(19) United States
(12) Patent Application Publication
(10) Pub. No.: US 2003/0035443 A1
(43) Pub. Date: Feb. 20, 2003

(54) Integrated access device-resident, robbed in-band time slot mechanism for effecting contemporaneous management of remote digital communication units

(75) Inventors: Coleman D. Bagwell, Madison, AL (US); David M. Lee II, Huntsville, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Adtran, Inc., Huntsville, AL

(21) Appl. No.: 09/932,640

(22) Filed: Aug. 17, 2001

(51) Int. Cl. H04J 3/00

(52) U.S. Cl. 370/498; 370/523

(57) ABSTRACT

Hardware and resource usage penalties associated with the conventional remote device management approach of occupying a robbed DS0 channel for only one management session at a time are obviated by programming a multi-digital circuit servicing host site-resident integrated access device to provide for effective simultaneous management of multiple remote digital communication devices by one or more workstations. Although only a single robbed in-band (T1) channel per remote site is used, it is unnecessary to terminate each high speed digital (T1) link with an associated T1 Service Unit and ISDN Service Unit pair at the central office site.

### FIELD OF THE INVENTION

The present invention relates in general to communication systems and components therefor, and is particularly directed to a new and improved remote communication device management mechanism, that is executable by the supervisory communication control processor of a digital subscriber line (DSL) communication unit, such as an integrated access device (IAD), and through which a user may effectively simultaneously or contemporaneously manage (controllably configure, read the status of, etc.) a number of remote customer premises equipments (CPEs), via robbed in-band channels of respective time division multiplexed (TDM) digital communication links of a telecommunication service provider, through which access to a public switched telephone network (PSTN) serving remote customers is provided.

### BACKGROUND OF THE INVENTION

Many users of digital communication networks, such as but not limited to financial, educational, medical, industrial and governmental institutions, whose operations rely upon vast amounts of archival storage and large main frame data processing systems, have traditionally employed legacy telecommunication systems and protocols to transport data from one point to another. A reduced complexity diagram of such a digital communication network is diagrammatically illustrated in FIG. 1, wherein a host/master data terminal 10 communicates over a plurality of dedicated data links (e.g., T1 links) 12 to a PSTN 14 serving various voice/data terminal equipments installed at a plurality of remote sites 16.

With ongoing improvements in digital communication technology, telecommunication service providers currently prefer to offer their customers digital subscriber line (DSL) communication technology, that takes advantage of higher communication speeds and information processing capacities. Although DSL schemes enable the transport of any type of user data between remote sites, successful installation and operation of a respective piece of communication equipment requires that it be continuously managed or supervised.

This is customarily accomplished by robbing one of the DS0 channels of the T1 link and using the robbed channel to conduct a supervisory management/control session with a respectively addressed piece of communication equipment. To accommodate the possibility of an interruption in service over its associated T1 link, each site employs an auxiliary (reduced bandwidth and speed) Basic Rate Interface (BRI) link 18, (dial-back) access to which is afforded via an Integrated services digital network (ISDN) Service Unit (ISU) 19, which is coupled to the T1 Service Unit (TSU) 20 for the T1 link of interest. At the host/master data terminal 10, the various T1 links 12 are also terminated at respective local TSU/ISU pairs 22/23. The local TSU/ISU pairs 22/23 are daisy-chained to the host site's supervisory communication processor 24 via a serial control link 26.

In order to initiate a management session with a given piece of equipment, the user/operator of the data terminal 10 issues a message containing (the address of) that piece of equipment, for example, from a management station 11. This message is forwarded from the data terminal's supervisory processor 13 over a robbed in-band DSO channel over the local supervisory control link 26, and is read by each local TSU/ISU pair 22/23. If the message is not intended for a receiving device, it is forwarded to the next daisy chained device. In addition, it is forwarded over the associated T1 links 12 to the various remote sites' ISU/TSUs 19/20. only the device for whom the message is intended will respond. The others simply pass the message on.

Once the addressed device has responded and a management session communication link has been established between the host and the device, the robbed DS0 channel is dedicated to only the ongoing management session between them, and remains so dedicated, until the management session between management station 11 and the addressed (ISU, TSU) device is terminated. Unfortunately, this one-to-one management session approach severely limits the use of available resources, as its mandates the need for redundant sets of TSUs and ISUs terminating the T1 links at the master terminal, as well as limiting the availability of the robbed in-band DS0 channel for only one management session at a time.

### SUMMARY OF THE INVENTION

In accordance with the present invention, advantage is taken of the communication signal processing capability and capacity of a multi-digital circuit servicing host IAD equipment, to provide contemporaneous management of multiple remote digital communication devices (TSU/ISUs) by way of a respective robbed in-band (T1) channel per remote site, and without having to terminate each high speed digital (T1) link with an associated TSU/ISU pair at the master site. As a non-limiting example, the IAD may comprise an Atlas 800^{PLUS} IAD, manufactured by Adtran Corp., Huntsville, Ala. It should be observed, however, that the invention is not limited to use with this or any other particular type of integrated access device, but is intended as an augmentation to the communication supervisory control mechanisms employed in IADs supplied from a variety of communication equipment manufacturers. Since the IAD itself terminates each digital (T1/T3) link, redundant TSU/ISU pairs that would otherwise be used at the central office can now be used to expand telecom service to additional customer sites.

The multi-digital circuit servicing IAD in which the present is installed is coupled to one or more user SNMP workstations. It is further coupled over a T1/T3 digital communication link to the PSTN. The network structure between the PSTN and the remote sites remains unchanged from that of FIG. 1, with the PSTN being coupled over respective T1 links and dial-back BRI links to voice/data terminal devices (ISUs/TSUs) at the remote sites. Using a distributed device-based data link protocol for the DS0 channel structure, the IAD establishes a management session and forwards user commands over a respectively robbed in-band channel to an addressed remote device.

In response to these user commands, the identified remote device returns response messages back to the IAD, which forwards then on to the local user SNMP terminal. Unlike the system of FIG. 1, which dedicates the robbed in-band DS0 channel for only one device management session at a time, the invention distributes respective robbed in-band DS0 channels among all of the remote devices, making it is effectively simultaneously available for additional sessions with other remote units, depending upon user invoked activity with respectively identified remote devices from the SNMP workstation(s).

To initiate a session with a remote device, a user logs onto the IAD, as by invoking a telecommunication network (TELNET) session or by means of a chain-in port. Via a device (client) menu, the (SNMP) user enters the address (device ID) of the remote device with which the management session is to be conducted. The IAD employs a respective robbed in-band DSO channel to establish a connection with the identified remote device. During a management session, the SNMP IAD may become an SNMP request proxy and/or an SNMP trap proxy for the remote device, using dedicated menu selection identifiers for the purpose in accordance with standard user interface menu selections. All SNMP requests from the user workstation are forwarded to the IP address associated with the IAD. To denote that a message is intended for a remote unit, the address or ID is appended to the community identifier of the IAD, so that the request will be forwarded to the identified remote device.

Once a connection is established, a remote device's user interface is displayed at the SNMP workstation. The display of a remote device user interface provides the SNMP workstation user with the ability to configure the remote device, as if directly connected to the remote device. Events from the workstation and response messages from one or more remote devices inserted into the respective robbed in-band DSO channels are then processed. Thus, the IAD becomes a transparent interface between an SNMP workstation and a remote device, using its robbed in-band message routing functionality to multiplex one or more management messages to one or more remote devices. When a session has been completed, the user terminates the connection. However, as it continuously monitors the robbed DS0 channels, for its ID in all traffic being carried by the management channel, the remote device management mechanism is effectively continuously ‘up’ for user-to-remote device sessions.

There is no modification of the control software employed by a respective remote device to communicate with the IAD over a robbed channel. As far as the remote device is concerned, it is interfaced with a robbed DS0 channel in the same manner as in the system of FIG. 1. When not participating in a management communication session over a robbed DSO channel, a respective remote device (ISU, TSU) is in an idle or ‘wait for message’ state. In association with the IAD transmitting a management session message, the remote device reads the contents of the robbed DS0 channel for the presence of its identification in any management message. When the ID in the message matches its unique ID, the remote device processes the received message. In addition to acting on commands contained in management messages, processing of a message includes returning the message back to the IAD which forwards the returned message back to the user SNMP workstation to indicate completion of requested action.

### BRIEF DESCRIPTION OF THE DRAWINGS

FIG. 1 is a reduced complexity diagram of a conventional digital communication network linking TSU and ISU devices at each of a plurality of remote sites with redundant pairs of TSU and ISU devices at a host/master data terminal;

FIG. 2 shows a modification of the digital communication network diagram of FIG. 1, in which TSU/ISU pairs at the host site have been replaced by a multi-digital circuit servicing IAD platform;

FIG. 3 shows the structure of a robbed DS0 channel used in the system of FIG. 2; and

FIGS. 4 and 5 show respective steps of the remote digital communication service unit management mechanism of the present invention.

### DETAILED DESCRIPTION

Before describing the improved remote digital communication service unit management mechanism according to the present invention, it should be observed that the invention resides primarily in a prescribed software routine, which is executable by the supervisory communications controller of a multi-digital circuit servicing IAD platform, such as above-referenced Atlas 800^{PLUS} IAD, that is configured to control the operation of a plurality of digital telecommunication signalling units, such as multiple TSUs and ISUs, of a digital telecommunication system. Consequently, the configuration of such a system has illustrated in the drawings by readily understandable block diagrams, showing only those specific details that are pertinent to the present invention, so as not to obscure the disclosure with details which will be readily apparent to those skilled in the art having the benefit of the description herein. The remote digital communication service unit management mechanism itself has been illustrated in flow chart format, which is primarily intended to show the various steps of the invention in a convenient functional sequence, whereby the present invention may be more readily understood.

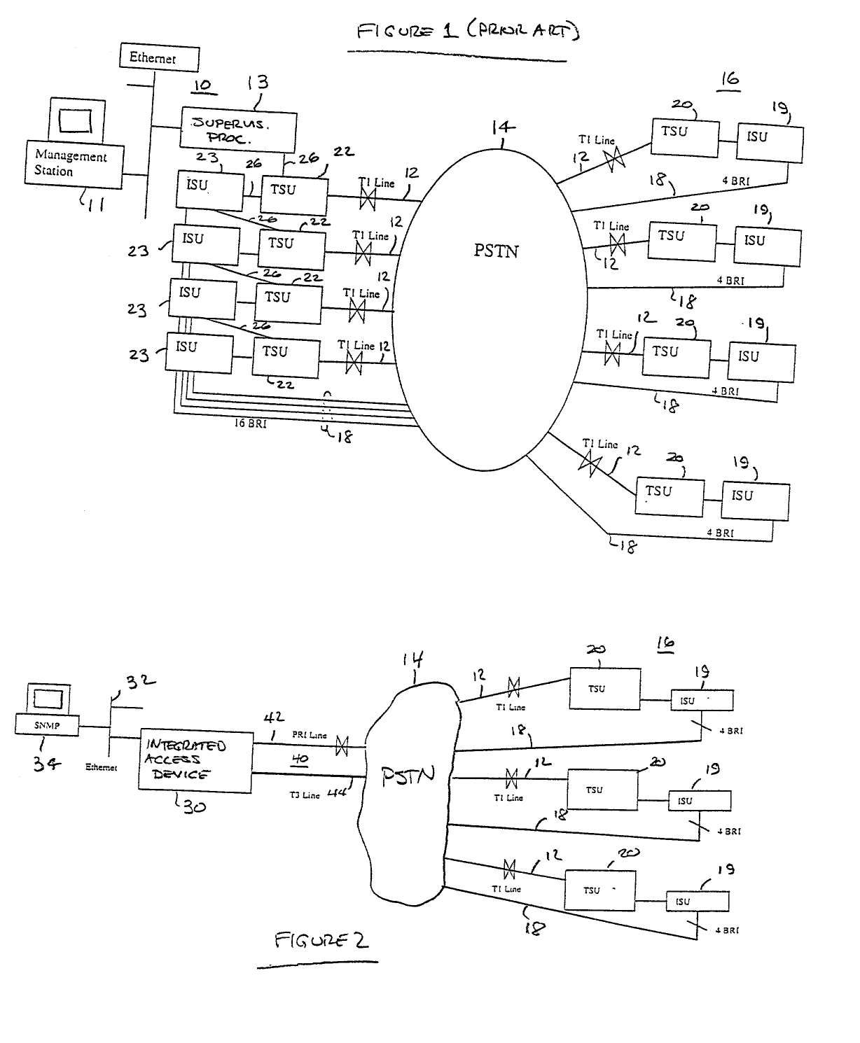

FIG. 2 shows a modification of the reduced complexity digital communication network diagram of FIG. 1, in which the TSU/ISU pairs and associated communication controller at the host/master site 10 have been replaced with a multi-digital circuit servicing IAD platform 30, such as above-referenced Atlas 800^{PLUS} IAD, as a non-limiting example. Because such an IAD has card slots for a plurality of (e.g., 34) T1 links or multiple channels of a T3 link, associated transceivers that interface directly with respective digital links to the PSTN, the need for individually installed local ISU and TSU pairs terminating associated T1 links with the PSTN is eliminated.

In the diagram of FIG. 2, the IAD 30 is coupled over a network (e.g., Ethernet) 32 to a simplified network management protocol (SNMP) workstation 34. It is further coupled to the PSTN 14 by way of a T1/T3 digital communication link 40, that includes a primary rate interface (PRI) segment 42 and a T3 segment 44. The network structure between the PSTN and the remote sites remains unchanged from that of FIG. 1, with the PSTN 14 being coupled over respective Ti links 12 and dial-back BRI links 18 to various voice/data terminal equipments ISUs 19 and TSUs 20 installed at remote sites 16, as discussed previously.

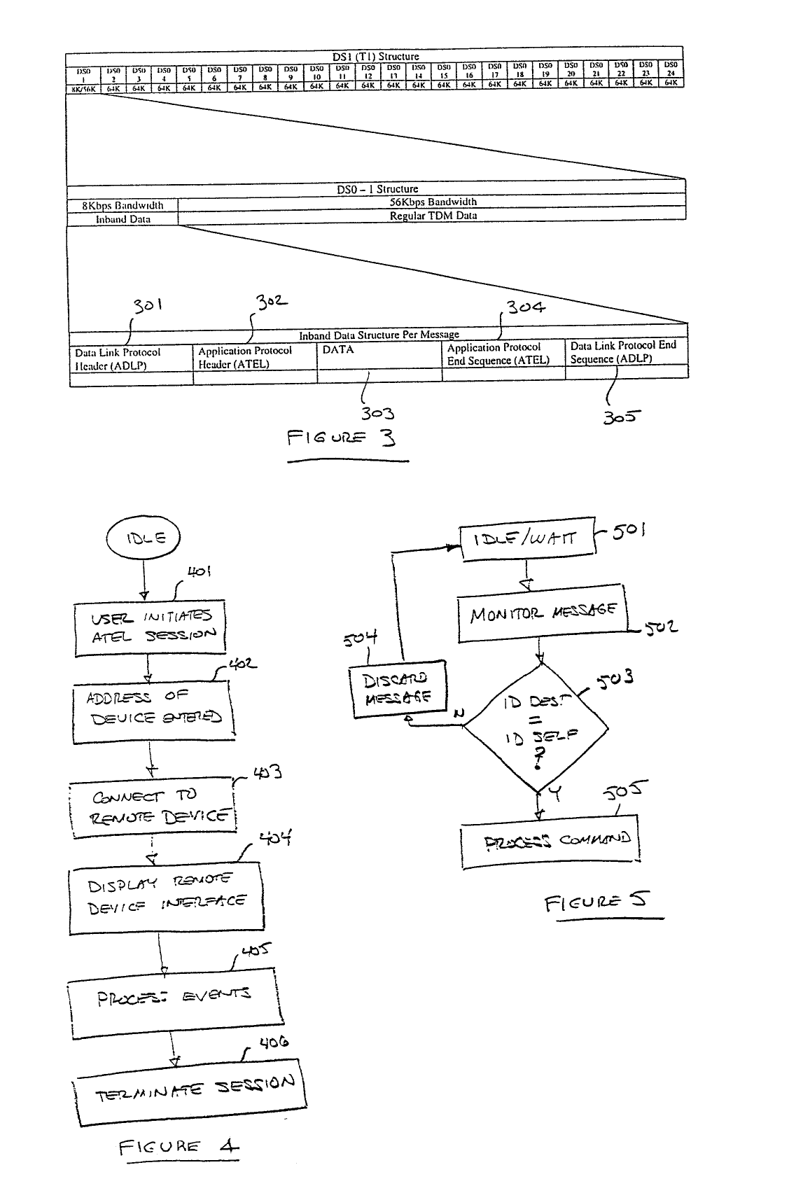

As described briefly above, using the data link protocol of the DS0 channel structure of FIG. 3 (to be described) for data transfers across the robbed in-band (8 Kbps) DS0 channel of a respective T1 channel 12, the remote digital communication service unit management mechanism of the invention establishes a management session and then forwards user commands to a respectively addressed remote device. In response to these user commands, the identified remote device returns response messages back to the IAD, which forwards then on to the local user SNMP terminal 34. However, unlike dedicating the robbed in-band DS0 channel to conduct only one device management session at a time, as in the architecture of FIG. 1, once a management session has been established in the system of FIG. 2, because the robbed channels are distributed (multiplexed) among all of the remote devices, they are available for additional sessions with other units at the same time, depending upon user invoked activity with respectively identified remote devices from the SNMP workstation.

For this purpose, the IAD 30 and the remote devices execute the software routine shown in the flow charts of FIGS. 4 and 5. To initiate a session with a remote device, in step 401, the user logs in to the IAD, as by invoking a telecommunication network (TELNET) session or by means of a chain-in port. Via a device (client) menu, in step 402, the user enters the address (device ID) of the remote device with which the management session is to be conducted. For security purposes, this may also include the entry of a unique password associated with the identified remote device.

In response to the user initiating a remote connection request, in step 403, the IAD uses an available (robbed) in-band DS0 channel to establish a connection with the identified remote device. The structure that may be employed for the robbed in-band DS0 channel (e.g., DS0-1) is shown in FIG. 3 as including a data link protocol header 301, an application protocol header 302, a data field 303, an application protocol end sequence 304 and a data link protocol end sequence 305. It should be noted that the invention is not limited to use with only DS0 channel one (DS0-1) or the structure shown in FIG. 3, which are merely provided as a non-limiting example.

Once a connection has been established with the identified remote device, the routine transitions to step 404 and displays the remote device's user interface. The display of a remote device user interface provides the SNMP workstation user with the ability to configure the remote device, as if directly connected to the remote device. With a connection established in step 403 to the identified remote device over the robbed in-band DS0 channel, events from the workstation and response messages from one or more remote devices that have been inserted into the robbed in-band DS0 channel are processed in step 405.

During a management session, the SNMP IAD may become an SNMP request proxy and/or an SNMP trap proxy for the remote device, using dedicated menu selection identifiers for the purpose in accordance with standard user interface menu selections. All SNMP requests from the user workstation are forwarded to the IP address associated with the IAD. To denote that a message is intended for a respective remote unit, the address or ID is appended to the community identifier of the IAD, so that the request will be forwarded to the identified remote device.

In other words, the IAD becomes a transparent interface between the SNMP workstation and the remote device, using its robbed in-band message routing functionality to multiplex one or more management messages to one or more remote devices. Once a session with a respective device has been completed, the user terminates the connection in step 406. However, since each remote device continuously monitors the robbed DS0 byte for its ID in all traffic being carried by the management channel, the remote device management mechanism is effectively continuously ‘open’ or ‘up’ for user-to-remote device sessions.

Associated with the IAD flow chart of FIG. 4 is the device flow chart of FIG. 5. It should be noted that the various steps of the flow chart of FIG. 5 do not represent a modification of the control software employed by the remote device to communicate with the IAD over a robbed channel, as the invention does not require modification of a remote device. Rather the steps of FIG. 5 simply show how a remote device responds to the IAD communication control routine of FIG. 4. As far as the remote device is concerned, it is interfaced with a robbed DS0 channel in the same manner as in the system of FIG. 1.

As shown at step 501 of FIG. 5, when not participating in a management communication session over the robbed DSO channel (here with the IAD), the remote device (ISU, TSU) is in an idle or ‘wait for message’ state. In association with the IAD transmitting a management session message to a remote device in step 403, described above, in step 502, the remote device monitors (reads) the contents of the robbed DS0 channel for the presence of its identification in any management message. Next, in query step 503, a determination is made as to whether the ID contained in the message matches the unique ID of that remote device. If the answer to the query step 503 is NO, the message is discarded in step 504 and the routine returns to step 501. On the other hand, if the answer to the query step 503 is YES (indicating that the message is intended for that remote device), the routine transitions to step 505 and processes the received message. As pointed out earlier, in addition to acting on commands contained in management messages, processing of a message in step 505 includes returning the message back to the IAD 30, which forwards the returned message back to the user terminal (SNMP workstation 34) to indicate completion of the requested action.

As will be appreciated from the foregoing description, the hardware intensity and resource usage inefficiency drawbacks of the conventional remote device management approach, which dedicates a robbed DS0 channel to only a single management session between a host management site and a remote device at a time, are effectively obviated by taking advantage of the signal processing capability and capacity of a multi-digital circuit servicing host IAD equipment, and installing therein a mechanism that provides for effective simultaneous management of multiple remote digital communication devices (TSU/ISUs) by one or more SNMP workstations. Although only one respective robbed in-band (T1) channel is used per remote site, it is unnecessary to terminate each high speed digital (T1) link with an associated TSU/ISU pair at the master site.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

What is claimed:

1. For use with a digital subscriber line (DSL) communication unit that is configured to provide access to plural remote digital communication devices via a telecommunication network, a method of managing operational characteristics of said remote digital communication devices comprising the steps of:
(a) establishing contemporaneous management communication sessions with said plural remote digital communication devices over robbed in-band digital communication channels of respective time-division-multiplexed (TDM) digital communication links employed by said DSL communication unit to conduct TDM digital communications with said plural remote digital communication devices; and
(b) transporting user commands over said robbed in-band digital communication channels to respectively addressed ones of said remote devices during said contemporaneous management communication sessions.

2. The method according to claim 1, wherein step (b) further includes transporting responses to said user commands, by said addressed ones of said remote devices, over said robbed in-band digital communication channels to said DSL communication unit, during said contemporaneous management communication sessions.

3. The method according to claim 1, wherein step (a) includes causing said DSL communication unit to establish said contemporaneous management communication sessions with said plural remote digital communication devices by way of a user management terminal coupled to said DSL communication unit.

4. The method according to claim 1, wherein step (a) includes, in response to receipt of a message from said user management terminal containing the identification of a respective remote digital communication device for whom a management communication session is to be conducted, transporting a message over a respective robbed in-band digital communication channel from said DSL communication unit containing said identification of said respective remote communication device.

5. The method according to claim 1, wherein step (a) includes causing said DSL communication unit to establish said contemporaneous management communication sessions with said plural remote digital communication devices by way of a user management terminal coupled to said DSL communication unit, and wherein step (b) further comprises, during said contemporaneous management communication sessions, transporting responses by said addressed ones of said remote devices to said user commands, over said robbed in-band digital communication channels to said DSL communication unit, and forwarding said responses to said user management terminal.

6. For use with a digital telecommunication network providing digital subscriber line (DSL) service over respective time-division-multiplexed (TDM) digital communication links to a plurality of remote digital communication devices, a method remotely managing one or more operational parameters of said plurality of remote digital communication devices, comprising the steps of:
(a) interfacing said TDM digital communication links with an integrated access device (IAD) that is configured to provide access to said plurality of remote digital communication devices;
(b) via a user management terminal coupled to said IAD, establishing contemporaneous management communication sessions with said plural remote digital communication devices via robbed in-band digital communication channels of said TDM digital communication links; and
(c) transporting user commands over respective robbed in-band digital communication channels to respectively addressed ones of said remote devices during said contemporaneous management communication sessions.

7. The method according to claim 6, wherein step (c) further includes transporting responses to said user commands, by said addressed ones of said remote devices, over respective robbed in-band digital communication channels to said DSL communication unit, during said contemporaneous management communication sessions.

8. The method according to claim 6, wherein step (b) includes, in response to receipt of a message from said user management terminal containing the identification of a respective remote digital communication device for whom a management communication session is to be conducted, transporting a message over a robbed in-band digital communication channel of a respective TDM digital communication link from DSL communication unit containing said identification of said respective remote communication device.

9. The method according to claim 6, wherein step (c) further comprises, during said contemporaneous management communication sessions, transporting responses by said addressed ones of said remote devices to said user commands, over robbed in-band digital communication channels to said DSL communication unit, and forwarding said responses to said user management terminal.

10. An arrangement for managing operational characteristics of plural remote digital communication devices via a telecommunication network coupled thereto comprising:
a digital subscriber line (DSL) communication unit that is configured to provide access to said plural remote digital communication devices via said telecommunication network by way of respective time-division-multiplexed (TDM) digital communication links; and
a communications controller for said DSL communication unit and being operative to cause said DSL communication unit to establish contemporaneous management communication sessions with said plural remote digital communication devices over a robbed in-band digital communication channel of respective ones of said TDM digital communication links.

11. The arrangement according to claim 10, wherein said communications controller is operative to cause said DSL communication unit to transport user commands over robbed in-band digital communication channels of said respective links to respectively addressed ones of said remote devices during said contemporaneous management communication sessions.

12. The arrangement according to claim 10, wherein, in response to receipt of a message a said user management terminal containing the identification of a respective remote digital communication device for whom a management communication session is to be conducted, said communications controller is operative to cause said DSL communication unit to transport a message over a respective robbed in-band digital communication channel containing said identification of said respective remote communication device.

13. The arrangement according to claim 10, wherein said communications controller is operative, during said contemporaneous management communication sessions, to cause said DSL communication unit to forward to said user management terminal responses to said user commands, as received over robbed in-band digital communication channels from said addressed ones of said remote devices.
